(19) United States
(12) Patent Application Publication
(10) Pub. No.: US 2021/0323824 A1
(43) Pub. Date: Oct. 21, 2021

(54) SOLID LITHIUM ION CONDUCTING MATERIAL AND PROCESS FOR PREPARATION THEREOF

(71) Applicants: BASF SE, Ludwigshafen am Rein (DE); University of Waterloo, Waterloo (CN)

(72) Inventors: Linda Nazar, Waterloo (CA); Torben Adermann, Ludwigshafen (DE); Joern Kulisch, Ludwigshafen (DE); Pascal Hartmann, Ludwigshafen (DE); Laidong Zhou, Waterloo (CA)

(21) Appl. No.: 17/267,604

(22) PCT Filed: Aug. 20, 2019
(86) PCT No.: PCT/EP2019/072298

§ 371 Date: Feb. 10, 2021

(30) Foreign Application Priority Data
Aug. 23, 2018 (EP) 18190512.6

(51) Int. Cl. C01B 25/455; H01M 10/0525; H01M 10/0562; C01B 25/26

(52) U.S. Cl. CPC C01B 25/455; H01M 10/0525; H01M 10/0562; C01P 2006/40; H01M 2300/008; C01P 2002/72; C01B 25/265

(57) ABSTRACT

Described are a solid material which has ionic conductivity for lithium ions, a process for preparing said solid material, a use of said solid material as a solid electrolyte for an electrochemical cell, a solid structure selected from the group consisting of a cathode, an anode and a separator for an electrochemical cell, and an electrochemical cell comprising such solid structure.

Described are a solid material which has ionic conductivity for lithium ions, a process for preparing said solid material, a use of said solid material as a solid electrolyte for an electrochemical cell, a solid structure selected from the group consisting of a cathode, an anode and a separator for an electrochemical cell, and an electrochemical cell comprising such solid structure.

Due to the wide-spread use of all solid state lithium batteries, there is an increasing demand for solid state electrolytes having a high conductivity for lithium ions. An important class of such solid electrolytes are materials of the composition Li₆PS₅X (X=Cl, Br) which have an argyrodite structure. However, synthesis of said Li-argyrodites is an all-solid state-synthesis involving reactive milling (usually ball-milling) of the precursors over a long duration, followed by heat treatment. For details, see e.g. EP 2 197 795. The ball milling process consumes much energy and time, has a low yield in terms of volume and time and makes the synthesis difficult to scale up.

Recently, Yubuchi et al. (ACS Appl. Energy Mater., DOI: 10.1021/acsaem.8b00280 Publication Date (Web): 11 Jul. 2018) described a process wherein argyrodite-type materials of the composition Li₆PS₅X (X=Cl, Br, I) obtained in the conventional manner by ball milling were dissolved in alcohol under a dry argon atmosphere The prepared solutions were heated at 2° C. min⁻¹ and then dried at 80, 150, or 200° C. under vacuum for 3 h. Unfortunately, it was observed that in some cases the ionic conductivity decreased as a result of the dissolution in alcohol. It is important to note that the dissolution-precipitation treatment described by Yubuchi at al. is carried out after conventional synthesis by reactive milling and does not replace reactive milling.

Related art is also
S. J. Sedlmaier et al., Chemistry of Materials, vol. 29, no. 4, 28 Feb. 2017, pp 1830-1835;
E. Rangasamy et al., Journal of the American Chemical Society, vol. 137, no. 4, 4 Feb. 2015, pp. 1384-1387;
US 2017/162901 A1.

Accordingly, there is a need for a more efficient, facile and scalable synthesis of lithium ion conducting materials of the argyrodite-type without compromising the ionic conductivity and other important properties like chemical and mechanical stability.

It is an objective of the present invention to provide a more efficient process for synthesizing lithium ion conducting solid materials having at least similar ionic conductivity, chemical and mechanical stability and processability like those lithium argyrodites obtained by the conventional process involving reactive milling.

Surprisingly it has been found that such solid materials are obtainable by means of a solution-based synthesis followed by drying and heat treatment of the obtained product. In addition, it has been found that although the composition of the solid materials obtainable by means of said solution-based synthesis is slightly different from those obtainable by the conventional process involving reactive milling, they exhibit superior lithium ion conductivity.

According to a first aspect of the present invention, there is provided a solid material comprising Li, P, S, O, and one or more selected from the group consisting of Cl, Br and I in a molar ratio according to general formula (I)

LiₐPS_{b}O_{c}X_{d}Yₑ (I)

wherein

X and Y are different and are selected from the group consisting of Cl, Br and I

a is in the range of from 4.5 to 7.5, preferably 5.4 to 6.5,

b is in the range of from 3.0 to 5.4, preferably 3.0 to 5, more preferably 3.9 to 4.9,

c is in the range of from 0.1 to 2, preferably 0.2 to 1.6, more preferably 0.4 to 1.3,

b+c is in the range of from 4.4 to 6, preferably 4.6 to 5.8,

d is in the range of from 0 to 1.6, preferably 0 to 1.5, more preferably 0 to 1.3,

e is in the range of from 0 to 1.6, preferably 0 to 1.5, more preferably 0 to 1.3,

d+e is in the range of from 0.4 to 1.8, preferably 0.5 to 1.7, more preferably 0.9 to 1.7,

b+c+d+e is in the range of from 4.8 to 7.6, preferably 5.5 to 6.7.

It is understood that formula (I) is an empirical formula (gross formula) determined by means of elemental analysis. Accordingly, formula (I) defines a composition which is averaged over all phases present in the solid material.

Preferred solid materials according to the invention consist of Li, P, S, O, and one or more selected from the group consisting of Cl, Br and I in a molar ratio according to general formula (I).

It is important to note that in contrast to a lithium argyrodite obtained by the conventional process involving reactive milling, a solid material according to the present invention comprises a certain amount of oxygen. Without wishing to be bound by any theory, it is assumed that during the solvent-based synthesis, in a certain fraction of the structural units PS₄³⁻ (thiophosphate) the sulfur atoms are replaced by oxygen atoms, so that structural units PO₄³⁻ (phosphate) are formed (for details see below). Nevertheless, the solid materials according to the invention exhibit favorable lithium ion conductivity.

In the solid materials according to the invention, preferably a=3+2(b+c−4)+d+e.

In certain preferred solid materials according to the invention

a is in the range of from 5.4 to 6.5,

b is in the range of from 3.0 to 5,

c is in the range of from 0.2 to 1.6,

b+c is in the range of from 4.6 to 5.8,

d is in the range of from 0 to 1.5,

e is in the range of from 0 to 1.5,

d+e is in the range of from 0.5 to 1.7,

b+c+d+e is in the range of from 5.5 to 6.7.

In said preferred solid materials, preferably a=3+2(b+c−4)+d+e.

Further preferably,

a is in the range of from 5.4 to 6.5,

b is in the range of from 3.9 to 4.9,

c is in the range of from 0.4 to 1.3,

b+c is in the range of from 4.6 to 5.8,

d is in the range of from 0 to 1.3,

e is in the range of from 0 to 1.3,

d+e is in the range of from 0.9 to 1.7,

b+c+d+e is in the range of from 5.5 to 6.7.

In said preferred solid materials, preferably a=3+2(b+c−4)+d+e.

In preferred solid materials according to the present invention, X and Y are selected from the group consisting of Cl and Br. Preferably, said solid materials consist of Li, P, S, O, and one or both of Cl and Br in a molar ratio according to general formula (I).

In certain preferred solid materials according to the invention X is Cl and Y is not present

a is in the range of from 4.5 to 7.5, preferably 5.4 to 6.5,

b is in the range of from 3.0 to 5.4, preferably 3.0 to 5, more preferably 3.9 to 4.9,

c is in the range of from 0.1 to 2, preferably 0.2 to 1.6, more preferably 0.4 to 1.3,

b+c is in the range of from 4.4 to 6, preferably 4.6 to 5.8,

d is in the range of from 0.4 to 1.6, preferably 0.5 to 1.5, more preferably 0.9 to 1.5,

e is 0,

b+c+d is in the range of from 4.8 to 7.6, preferably 5.5 to 6.7.

In said preferred solid materials, preferably a=3+2(b+c−4)+d.

Further preferably, in said solid materials wherein X is Cl and Y is not present

a is in the range of from 5.4 to 6.5,

b is in the range of from 3.0 to 5,

c is in the range of from 0.2 to 1.6,

b+c is in the range of from 4.6 to 5.8,

d is in the range of from 0.5 to 1.5,

e=0,

b+c+d is in the range of from 5.5 to 6.7.

In said preferred solid materials, preferably a=3+2(b+c−4)+d.

Most preferably, in said solid materials wherein X is Cl and Y is not present

a is in the range of from 5.4 to 6.5,

b is in the range of from 3.9 to 4.9,

c is in the range of from 0.4 to 1.3,

b+c is in the range of from 4.6 to 5.8,

d is in the range of from 0.9 to 1.5,

e=0

b+c+d is in the range of from 5.5 to 6.7.

In said preferred solid materials, preferably a=3+2(b+c−4)+d.

Preferably, said solid materials wherein X=Cl and Y is not present consist of Li, P, S, O and Cl in a molar ratio according to general formula (I) as defined above.

In certain other preferred solid materials according to the invention Y is Br and X is not present,

a is in the range of from 4.5 to 7.5, preferably 5.4 to 6.5,

b is in the range of from 3.0 to 5.4, preferably 3.0 to 5, more preferably 3.9 to 4.9,

c is in the range of from 0.1 to 2, preferably 0.2 to 1.6, more preferably 0.4 to 1.3,

b+c is in the range of from 4.4 to 6, preferably 4.6 to 5.8,

d=0,

e is in the range of from 0.4 to 1.6, preferably 0.5 to 1.5, more preferably 0.9 to 1.5,

b+c+e is in the range of from 4.8 to 7.6, preferably 5.5 to 6.7.

In said preferred solid materials, preferably a=3+2(b+c−4)+e.

Further preferably, in said solid materials wherein Y is Br and X is not present

a is in the range of from 5.4 to 6.5,

b is in the range of from 3.0 to 5,

c is in the range of from 0.2 to 1.6,

b+c is in the range of from 4.6 to 5.8,

d=0,

e is in the range of from 0.5 to 1.5,

b+c+e is in the range of from 5.5 to 6.7.

In said preferred solid materials, preferably a=3+2(b+c−4)+e.

Most preferably, in said solid materials wherein Y is Br and X is not present

a is in the range of from 5.4 to 6.5,

b is in the range of from 3.9 to 4.9,

c is in the range of from 0.4 to 1.3,

b+c is in the range of from 4.6 to 5.8,

d=0,

e is in the range of from 0.9 to 1.5,

b+c+e is in the range of from 5.5 to 6.7.

In said preferred solid materials, preferably a=3+2(b+c−4)+e.

Preferably, said solid materials wherein Y=Br and X is not present consist of Li, P, S, O, and Br in a molar ratio according to general formula (I) as defined above.

In certain other preferred solid materials according to the invention X is Cl and Y is Br

a is in the range of from 4.5 to 7.5, preferably 5.4 to 6.5,

b is in the range of from 3.0 to 5.4, preferably 3.0 to 5, more preferably 3.9 to 4.9,

c is in the range of from 0.1 to 2, preferably 0.2 to 1.6, more preferably 0.4 to 1.3,

b+c is in the range of from 4.4 to 6, preferably 4.6 to 5.8,

d is in the range of from 0.01 to 1.5, preferably 0.2 to 1.3, more preferably 0.25 to 1, most preferably 0.33 to 1,

e is in the range of from 0.01 to 1.5, preferably 0.2 to 1.3, more preferably 0.25 to 1, most preferably 0.33 to 1, d+e is in the range of from 0.4 to 1.8, preferably 0.5 to 1.7, more preferably 0.9 to 1.7,

b+c+d+e is in the range of from 4.8 to 7.6, preferably 5.5 to 6.7.

In said preferred solid materials, preferably a=3+2(b+c−4)+e.

Further preferably, in said solid materials wherein X is Cl and Y is Br,

a is in the range of from 5.4 to 6.5,

b is in the range of from 3.0 to 5,

c is in the range of from 0.2 to 1.6,

b+c is in the range of from 4.6 to 5.8,

d is in the range of from 0.2 to 1.3,

e is in the range of from 0.2 to 1.3,

d+e is in the range of from 0.5 to 1.7,

b+c+d+e is in the range of from 5.5 to 6.7.

In said preferred solid materials, preferably a=3+2(b+c−4)+d+e.

Most preferably, in said solid materials wherein X is Cl and Y is Br

a is in the range of from 5.4 to 6.5,

b is in the range of from 3.9 to 4.9,

c is in the range of from 0.4 to 1.3,

b+c is in the range of from 4.6 to 5.8,

d is in the range of from 0.25 to 1, preferably 0.33 to 1,

e is in the range of from 0.25 to 1, preferably 0.33 to 1,

d+e is in the range of from 0.9 to 1.7,

b+c+d+e is in the range of from 5.5 to 6.7.

In said preferred solid materials, preferably a=3+2(b+c−4)+d+e.

More specifically, in preferred solid materials wherein X is Cl and Y is Br,

d+e is in the range of from 0.9 to 1.7, and the ratio of d/e is in the range of from 1:150 to 150:1, preferably of from 1:4 to 4:1, more preferably of from 1:3 to 3:1.

Preferably, said solid materials wherein X=Cl and Y=Br consist of Li, P, S, O, Cl and Br in a molar ratio according to general formula (I) as defined above.

It was observed that the lithium ion conductivity is maximum when Li, P, S, O, and one or both of Cl and Br are present in the preferred ranges and ratios defined above.

Preferably in the solid materials according to the invention the ratio b/c (i.e. the molar ratio S/O) is in the range of from 1.5 to 40, preferably of from 3 to 20. A higher ratio b/c (lower fraction of O) is difficult to obtain, because apparently a certain degree of replacement of sulfur in the structural units PS₄³⁻ by oxygen inevitably occurs during the solvent based synthesis. At a lower ratio b/c (higher fraction of O), the composition of the solid material is too far apart from the composition of the lithium argyrodites obtained by the conventional process involving reactive milling, and such different composition may have negative effects on the lithium ion conductivity, chemical and mechanical stability and/or processability.

Further preferably, in the solid materials according to the invention the ratio (b+c)/(d+e) (i.e. the molar ratio of the total amount of S and 0 vs. the total amount of X and Y is in the range of from 2 to 6, preferably 2.8 to 5.2.

A solid material according to the invention typically contains a fraction consisting of one or more crystalline phases as detectable by the X-ray diffraction technique. Preferably said fraction of crystalline phases makes up for 5% or more, preferably 20% or more, further preferably 50% or more, or even 70% or more of the total weight of the solid material.

Preferably, one of said crystalline phases has the argyrodite structure. More preferably, said crystalline phase having the argyrodite structure makes up for 70% or more of the total weight of the fraction consisting of crystalline phases, in especially preferred cases for 80% or more of the total weight of the fraction consisting of crystalline phases, or even for 90% or more of the total weight of the fraction consisting of crystalline phases. The reminder of the fraction consisting of crystalline phases typically comprises one or more of LiCl, LiBr, Li₂S and Li₃PO₄.

Especially preferable, a solid material according to the invention consists of one or more crystalline phases as detectable by the X-ray diffraction technique, wherein one of said crystalline phases has the argyrodite structure. More preferably, said crystalline phase having the argyrodite structure makes up for 70% or more of the total weight of the fraction consisting of crystalline phases, in especially preferred cases for 80% or more of the total weight of the fraction consisting of crystalline phases, or even for 90% or more of the total weight of the fraction consisting of crystalline phases. The reminder of the fraction consisting of crystalline phases typically comprises one or more of LiCl, LiBr, Li₂S and Li₃PO₄.

It was observed by means of ³¹P MAS NMR that in certain cases a solid material according to the invention comprises structural units PS₄³⁻ and structural units PO₄³⁻. Interestingly, ³¹P MAS NMR studies did not provide evidence for a significant presence of structural units PSₓO_{y}³⁻ wherein x>0, y>0, and x+y=4.

Preferably the ratio between the amount of structural units PS₄³⁻ and the amount of structural units PO₄³⁻ is in the range of from von 30:1 to 1.5:1, preferably 15:1 to 3:1. A higher ratio between the amount of structural units PS₄³⁻ and structural units PO₄³⁻ corresponds to a lower fraction of 0 which is difficult to obtain, because apparently a certain degree of replacement of sulfur in the structural units PS₄³⁻ by oxygen inevitably occurs during the solvent based synthesis. At a lower ratio between the amount of structural units PS₄³⁻ and structural units PO₄³⁻, corresponding to a higher fraction of O, the composition of the solid material is too far apart from the composition of the lithium argyrodites obtained by the conventional process involving reactive milling, and such different composition may have negative effects on the lithium ion conductivity, chemical and mechanical stability and/or processability.

Favorably, the solid materials according to the invention exhibit high conductivities for lithium ions, preferably 1 mS/cm or more, in more preferred cases 1.3 mS/cm or more, or even 1.8 mS/cm or more and in most preferred cases 2 mS/cm or more. The ionic conductivity was determined in the usual manner known in the field of battery materials development by means of electrochemical impedance spectroscopy (for details see examples section below).

At the same time, the solid materials according to the invention exhibit an almost negligible electronic conductivity. More specifically the electronic conductivity is 10⁻⁵ mS/cm or lower, i.e. at least 5 orders of magnitude lower than the ionic conductivity, in most cases at least 6 orders of magnitude lower than the ionic conductivity. The electronic conductivity was determined in the usual manner known in the field of battery materials development by means of direct-current (DC) polarization measurements at different voltages (for details see examples section below).

Preferred solid materials according to the first aspect of the invention are those having one or more of the preferred features disclosed above in the context of the first aspect of the invention.

According to a second aspect of the present invention, there is provided a process for obtaining a solid material. Preferably said solid material is a solid material according to the first aspect of the present invention as described above.

Said process according to the second aspect of the invention comprises the following process steps:
a) providing the precursors
   (1) a compound of formula (II)

Li₃PS₄ (II)
and/or
a mixture of Li₂S and P₂S₅ in a molar ratio in the range of from 2.7:1 to 3.3:1 preferably 2.9:1 to 3.1:1
(2) Li₂S
(3) one or more compounds selected from the group consisting of LiCl, LiBr and LiI
and
(4) one or more solvents selected from the group consisting of alkanols having 1 to 6 carbon atoms, preferably 1 to 3 carbon atoms, most preferably ethanol
(5) optionally one or more solvents selected from the group consisting of aprotic solvents, wherein said aprotic solvents are preferably selected from the group consisting of ethers, aliphatic hydrocarbons and aromatic hydrocarbons, most preferably one or both of tetrahydrofuran (THF) and toluene
b) preparing a mixture comprising the precursors and solvents provided in step a)
c) converting the mixture prepared in process step b) to a solid material by removing the solvents (4) and (5) (if present) so that a residue is obtained, and heating the obtained residue at a temperature in the range of from 50° C. up to 600° C., preferably in the range of from 500° C. to 600° C., thereby forming the solid material.

In step a), precursors and solvents for the mixture to be prepared in step b) are provided. Said mixture prepared in step b) is in the form of a solution of the precursors (1), (2) and (3) in the solvents (4) resp. in a mixture of the solvents (4) and (5). In step c), the mixture is transferred into a solid material by removing the solvents and subsequent heat treatment (sintering).

Different from conventional synthesis of lithium argyrodites, the process according to the second aspect of the present invention does not involve reactive-milling of the precursors (1), (2) and (3) resp. of a mixture thereof.

It is presently assumed that solution-based synthesis according to the second aspect of the invention provides an intimate mix of the precursors, potentially reducing the subsequent heat treatment temperature and/or time and reducing the formation of phases with lower conductivity.

The precursors and their molar ratio are selected according to the target stoichiometry. The target stoichiometry defines the ratio between the elements Li, S, P, and one or more selected from the group consisting of Cl, Br and I, which is obtainable from the applied amounts of the precursors (1), (2) and (3) under the condition of complete conversion without side reactions and other losses, not considering that during the solvent-based synthesis according to the second aspect of the invention in a certain fraction of the structural units PS₄³⁻ the sulfur atoms are replaced by oxygen atoms.

As the precursor (1) there is provided lithium thiophosphate which is a compound of formula (II)

Li₃PS₄ (II)

and/or

a mixture of Li₂S and P₂S₅ in a molar ratio in the range of from 2.7:1 to 3.3:1 preferably 2.9:1 to 3.1:1.

A precursor (1) in the form of the compound of formula (II) is usually preferred, but e.g. if said compound is not available, a mixture of Li₂S and P₂S₅ in a molar ratio close to the molar ratio of Li₂S/P₂S₅ defined by formula (II) may be applied. Said mixture is preferably suspended in tetrahydrofuran (THF).

The compound of formula (II) may be provided in solvated form

Li₃PS₄*g solv (II′)

wherein

solv is selected from the group consisting of tetrahydrofuran (THF), acetonitrile, dimethylether (DME), 1,3-dioxolane, 1,4-dioxane

g is in the range of from 1 to 4, preferably 2 to 3.5.

The synthesis of the compound of formula (II) is known in the art. Preferably the compound of formula (II) is prepared as described in WO 2018/054709 A1, example 1.1. Instead of dimethylether, a solvent selected from the group consisting of tetrahydrofuran (THF), acetonitrile, 1,3-dioxolane, 1,4-dioxane may be used in the synthesis described in WO 2018/054709 A1, example 1.1.

Synthesis of Li₃PS₄ is also described in Liang et al., Chem. Mater. 2014, 26, 3558-3564.

It is noted that synthesis of Li₃PS₄ as described in WO 2018/054709 A1 resp. in Liang et al., Chem. Mater. 2014, 26, 3558-3564 does not involve reactive milling.

Preferably the compound of formula (II) is used in solvated form. Doing so facilitates dissolution of the compound according to formula (II) in solvent (4). Especially preferably, the compound of formula (II) is solvated by THF

Li₃PS₄*g THF

wherein g is in the range of from 1 to 4, preferably 2 to 3.5.

The molar ratio of the total amount of Li in precursor (1) to the total amount of Li in precursors (2) and (3) is preferably in the range of from 3:5 to 3:1, more preferably 3:4.7 to 3:1.3, most preferably 3:4.6 to 3:1.4.

The molar ratio of Li in precursor (2) to Li in precursor (3) is preferably in the range of from 1:2 to 4:1, more preferably 2:3.5 to 3:1, most preferably 2:3 to 2:1.

The molar ratio of precursor (2) to precursor (3) is preferably in the range of from 1:4 to 2:1, more preferably of from 1:3 to 1:1.

The precursor (3) is preferably selected from LiCl, LiBr and mixtures of LiCl and LiBr. If precursor (3) is a mixture of LiCl and LiBr, the molar ratio LiCl/LiBr is preferably in the range of from 1:150 to 150:1, more preferably in the range of from 1:4 to 4:1, most preferably of from 1:3 to 3:1.

The total content of precursors (1), (2) and (3) in the mixture prepared in step b) is preferably in the range of from 1 wt.-% to 50 wt.-%, more preferably 2 wt. % to 25 wt. %, most preferably 4 wt. % to 15 wt. %, in each case based on the total weight of the mixture.

When solvent (5) is present, the weight fraction of solvent (5) is preferably not more than 70%, more preferably not more than 50%, based on the total weight of solvents (4) and (5).

The solvents (4) and (5) are selected to be completely miscible so that the mixture prepared in step b) comprises a single liquid phase.

Preferably the solvent (4) is an alkanol having 1 to 3 carbon atoms, most preferably ethanol.

Solvent (5) is an aprotic solvent not selected from the group consisting of alkanols. Preferably the solvent (5) is THF or toluene or a mixture of both.

Any solvent is applied in substantially anhydrous form. Preferably, the water content of solvent (4) (if no solvent (5) is present) resp. the water content of the mixture of solvents (4) and (5) is below 100 ppm, as determined by means of Karl-Fischer titration.

The mixture obtained in step b) by dissolving the precursors (1), (2) and (3) in the solvents as defined above is usually in the form of a clear solution.

Preferably, in step b) the constituents (2) and (3) are dissolved in solvent (4) resp. in a mixture of solvents (4) and (5), then constituent (1) is added and dissolved, and the obtained solution is stirred for 15 min to 24 hours, preferably for 30 min to 16 hours. In step b) preferably any handling is performed under a protective gas atmosphere in order to minimize, preferably exclude access of oxygen and moisture.

Without wishing to be bound by any theory, it is assumed that during step b), in the presence of a solvent (4) selected from the group consisting of alkanols having 1 to 6 carbon atoms, in a certain fraction of the structural units PS₄³⁻ (thiophosphate) the sulfur atoms are replaced by oxygen atoms originating from the solvent (4), so that structural units PO₄³⁻ (phosphate) are formed.

In step c) removal of the solvents is preferably achieved by subjecting the solution to a reduced pressure (relative to standard pressure 101.325 kPa). In order to remove the solvents as complete as possible, the obtained residue is further dried under reduced pressure at a temperature in the range of from 100° C. to 250° C. for a duration of from 15 min to 72 hours, preferably of from 30 min to 48 hours, more preferably 2 hours to 40 hours.

In step c), after removal of the solvent and further drying, heating of the obtained residue is preferably performed in a closed vessel for a duration of 1 to 12 hours, more preferably 4 to 8 hours, at a temperature in the range of from 50° C. up to 600° C., further preferably in the range of from 400° C. to 600° C., most preferably in the range of from 500° C. to 600° C.

The heat treatment carried out in step c) promotes formation of a crystalline phase having the argyrodite structure in the solid material, as described above in the context of preferred solid materials according to the first aspect of the invention.

If necessary, the solid material obtained by the process according to the invention as described above is ground (e.g. milled) into a powder. Preferably, said powder has a D₅₀ value of the particle size distribution of less than 100 μm, more preferably less than 20 μm, most preferably less than 10 μm, as determined by means of dynamic light scattering or image analysis.

Preferred processes according to the second aspect of the invention are those having one or more of the preferred features disclosed above in the context of the second aspect of the invention.

In a third aspect of the present invention, there is provided a solid material obtainable by a process according to the second aspect of the invention. Preferred solid materials according to the third aspect of the invention are those obtained by processes having one or more of the preferred features disclosed above in the context of the second aspect of the invention.

The solid materials according to the invention resp. obtained by the process according to the invention can be used as a solid electrolyte for an electrochemical cell. Herein preferably the solid electrolyte is a component of a solid structure for an electrochemical cell, wherein the solid structure is selected from the group consisting of cathode, anode and separator. Accordingly, the solid materials according to the invention resp. obtained by the process according to the invention can be used alone or in combination with additional components for producing a solid structure for an electrochemical cell, such as a cathode, an anode or a separator.

Thus, the present invention further provides the use of a solid material according to the invention resp. obtained by the process according to the invention as a solid electrolyte for an electrochemical cell. More specifically, the present invention further provides the use of a solid material according to the invention resp. obtained by the process according to the invention as a component of a solid structure for an electrochemical cell, wherein said solid structure is selected from the group consisting of cathode, anode and separator.

In the context of the present invention, the electrode where during discharging a net negative charge occurs is called the anode and the electrode where during discharging a net positive charge occurs is called the cathode. The separator electronically separates a cathode and an anode from each other in an electrochemical cell.

The cathode of an all-solid-state electrochemical cell usually comprises beside an active cathode material as a further component a solid electrolyte. Also the anode of an all-solid-state electrochemical cell usually comprises a solid electrolyte as a further component beside an active anode material.

The form of the solid structure for an electrochemical cell, in particular for an all-solid-state lithium battery, depends in particular on the form of the produced electrochemical cell itself.

The present invention further provides a solid structure for an electrochemical cell wherein the solid structure is selected from the group consisting of cathode, anode and separator, wherein the solid structure for an electrochemical cell comprises a solid material according to the invention resp. obtained by the process according to the invention.

The present invention further provides an electrochemical cell comprising a solid material according to the invention resp. obtained by the process according to the invention. Preferably, in said electrochemical cell the solid material according to the invention resp. obtained by the process according to the invention is a component of one or more solid structures selected from the group consisting of cathode, anode and separator.

The inventive electrochemical cell is preferably a rechargeable electrochemical cell comprising the following constituents

α) at least one anode,

β) at least one cathode,

γ) at least one separator,

wherein at least one of the three constituents is a solid structure selected from the group consisting of cathode, anode and separator comprising a solid material according to the invention resp. obtained by the process according to the invention.

Suitable electrochemically active cathode materials and suitable electrochemically active anode materials are known in the art. In an electrochemical cell according to the invention the anode a) preferably comprises graphitic carbon, metallic lithium or a metal alloy comprising lithium as the anode active material.

Electrochemical cells according to the invention are preferably selected from alkali metal containing cells. More preferably, inventive electrochemical cells are selected from lithium-ion containing cells. In lithium-ion containing cells, the charge transport is effected by Li⁺ ions.

For example, the electrochemical cell has a disc-like or a prismatic shape. The electrochemical cells can include a housing that can be from steel or aluminum.

A plurality of electrochemical cells according to the invention may be combined to an all solid-state battery, which has both solid electrodes and solid electrolytes. A further aspect of the present invention refers to batteries, more preferably to an alkali metal ion battery, in particular to a lithium ion battery comprising at least one inventive electrochemical cell, for example two or more. Inventive electrochemical cells can be combined with one another in inventive alkali metal ion batteries, for example in series connection or in parallel connection. Series connection is preferred.

The electrochemical cells resp. batteries described herein can be used for making or operating cars, computers, personal digital assistants, mobile telephones, watches, camcorders, digital cameras, thermometers, calculators, laptop BIOS, communication equipment or remote car locks, and stationary applications such as energy storage devices for power plants. A further aspect of the present invention is a method of making or operating cars, computers, personal digital assistants, mobile telephones, watches, camcorders, digital cameras, thermometers, calculators, laptop BIOS, communication equipment, remote car locks, and stationary applications such as energy storage devices for power plants by employing at least one inventive battery or at least one inventive electrochemical cell.

A further aspect of the present invention is the use of the electrochemical cell as described above in motor vehicles, bicycles operated by electric motor, robots, aircraft (for example unmanned aerial vehicles including drones), ships or stationary energy stores.

The present invention further provides a device comprising at least one inventive electrochemical cell as described above. Preferred are mobile devices such as are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The invention is illustrated further by the following examples which are not limiting.

### EXAMPLES

1. Preparation of Solid Materials

Step a)

The following precursors were provided:
(1) Li₃PS₄ x THF (x=2 to 3) obtained in the manner described in WO 2018/054709 A1 with the exception that THF was used as the solvent
(2) Li₂S (Sigma-Aldrich, 99.98%)
(3) Li halide(s), i.e. one or more of LiCl (Sigma-Aldrich, 99%), LiBr (Alfa Aesar, 99%) and LiI.

As the solvent (4), anhydrous ethanol (Sigma-Aldrich, anhydrous, dried with 3 Å molecular sieve 3 days before use) was provided.

Step b)

In an Argon-filled glovebox, (2) Li₂S and (3) Li halide were dissolved in (4) anhydrous ethanol. The molar ratio between Li₂S and Li halide was selected according to the target stoichiometry (see table 1 below). Solid Li₃PS₄ solvated with THF (1) was added to the solution in an amount according to the target stoichiometry (see table 1 below) and the mixture was stirred overnight to give a pale-yellow solution.

Step c)

Outside of the glovebox, the solvent was removed under reduced pressure while immersing the flask containing the solution prepared in step b) into a 100° C. hot oil bath. The obtained residue was a pale yellow/pink powder. The obtained residue was further dried under reduced pressure at 140° C. for 40 hours. Portions of 200 mg were pressed into pellets with a diameter of 13 mm and sealed into a carbon coated quartz tube under vacuum. The sample was heated to 550° C. at a rate of 5 K/min and kept at 550° C. for 6 hours. After cooling to ambient temperature, the pellet was removed from the quartz tube inside a glovebox and characterized chemically and electrochemically.

2. Structural and Chemical Characterization

X-ray diffraction (XRD) measurements were conducted at room temperature on a PANalytical Empyrean diffractometer with Cu-Kα radiation equipped with a PIXcel bidimensional detector. XRD patterns for phase identification were obtained in the Bragg-Brentano geometry, with samples placed on a zero-background sample holder in an Argon-filled glovebox and protected by Kapton film. Standard addition analysis was carried out by mixing the sample with 10 wt. % Si in an Argon-filled glovebox and sealed in glass capillaries (inner diameter 0.3 mm). XRD patterns were collected in the Debye-Scherrer geometry. Rietveld refinement was performed using the FullProf suit. Scale factor, zero point, background, lattice parameters, fraction coordinates, occupancies, and thermal parameters were sequentially reined in the argyrodite structure Li₆PS₅X (X=Cl, Br).

The element composition was determined by elemental analysis. The ratio between structural units PS₄³⁻ and structural units PO₄³⁻ was determined by means of quantitative solid state ³¹P MAS NMR.

The material morphology was examined using a Zeiss field emission scanning electron microscope (SEM) equipped with an energy dispersive X-ray spectroscopy detector (EDX).

3. Conductivity

The ionic conductivity was determined by means of electrochemical impedance spectroscopy (EIS) with a home-built setup. Typically, 100 mg of a powder of the material to be studied was placed between two stainless steel stamps, which closely fit into a tube made of polyether ether ketone (PEEK) with a length of 10 mm, an inner diameter of 10 mm and an outer diameter of approx. 30 mm. The setup is then pressed by a manual press at 375 MPa giving a symmetric cell having the configuration SS/solid lithium-conducting material/SS (SS=stainless steel). The pressure of 375 MPa was maintained during recording of the electrochemical impedance spectrum. EIS was performed with 20 mV amplitude within a frequency range of from 1 MHz to 1 Hz using a VMP3 potentiostat/galvanostat (Bio-logic) at room temperature. The pellet thickness was determined in-situ during the measurement using a digital micrometer, taking into account the compression of the stainless-steel stamps at the respective pressure.

Direct-current (DC) polarization curves at applied voltages of 0.25 V, 0.5 V and 0.75 V were recorded using the same cell configuration for 30 min each at room temperature to determine the electronic conductivities of samples.

4. Results

4.1 Overview

In table 1, the target stoichiometry, the result of the elemental analysis, the Li ion conductivity and the ratio between structural units PS₄³⁻ and structural units PO₄³⁻ are compiled.

The last two entries are comparison materials. Empty fields in table 1 mean that the related parameter has not been determined yet.

When the stoichiometry determined by elemental analysis as given in table 1 is recalculated so that the stoichiometric coefficient of P is 1, it can be seen that the solid materials according to the invention comprise Li, P, S, O, and one or both of Cl and Br in a molar ratio according to general formula (I).

It is observed that the solid materials according to the invention have superior Li ion conductivity.

TABLE 1

| | | | |
|---|---|---|---|
| | | Li-ion | |
| | | conduc- | |
| Target | Stoichiometry determined by elemental analysis | tivity | PS₄/PO₄- |

| Stoichiometry | Li | P | S | Cl | Br | O | [mS/cm] | ratio |
|---|---|---|---|---|---|---|---|---|
| Li₆PS₅Cl | 6 | 0.95 | 4.22 | 0.99 | 0 | 0.85 | 1.3 | 8.9:1 |
| Li₆PS₅Cl_{0.75}Br_{0.25} | | | | | | | 1.8 | |
| Li₆PS₅Cl_{0.5}Br_{0.5} | 6 | 0.93 | 4.51 | 0.72 | 0.55 | 0.72 | 2.2 | 11.7:1 |
| Li₆PS₅Cl_{0.25}Br_{0.75} | | | | | | | 1.8 | |
| Li₆PS₅Br | 6 | 0.93 | 4.52 | 0 | 1.0 | 0.77 | 1.0 | 13.3:1 |
| Li_{5.75}PS_{4.75}Cl_{1.25} | 5.75 | 1.0 | 4.15 | 1.22 | 0 | 0.9 | 1.1 | |
| Li_{5.5}PS_{4.5}Cl_{1.5} | 5.5 | 0.95 | 3.77 | 1.48 | 0 | 1.1 | 1.4 | |
| Li_{5.25}PS_{4.25}Cl_{1.75} | 5.25 | 0.95 | 2.22 | 1.7 | 0 | 2.4 | 0.2 | |
| Li₅PS₄Cl₂ | 5 | 0.92 | 2.64 | 2.0 | 0 | 1.3 | 0.3 | |

4.2 Crystal Structure and Morphology

For the sake of convenience, herein the samples of the tested materials are referred to by their target stoichiometry (cf. table 1 above), although the stoichiometry determined by elemental analysis is different from the target stoichiometry.

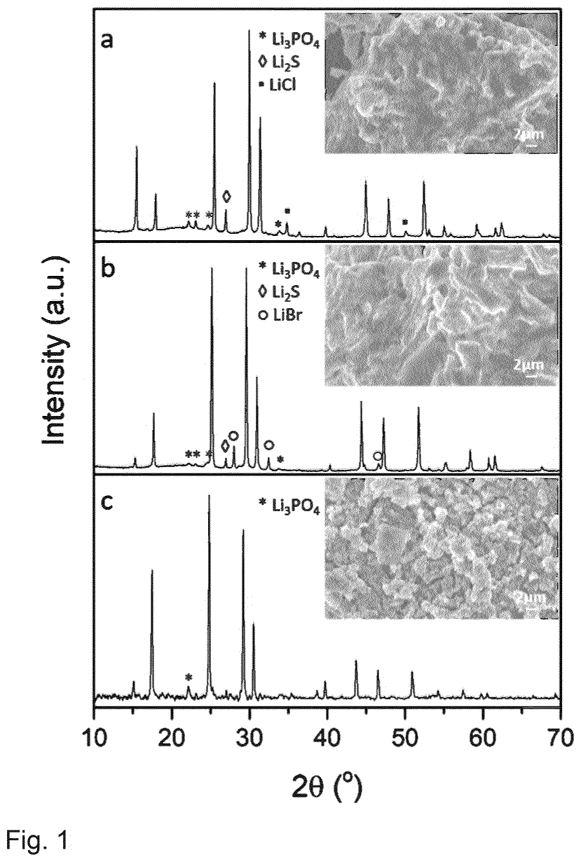

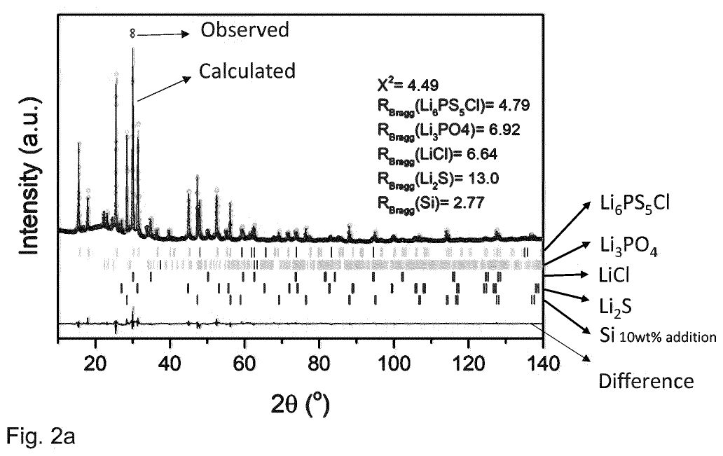

FIGS. 1a-c show XRD patterns of solid materials having the target stoichiometries Li₆PS₅Cl (FIG. 1a), Li₆PS₅Br (FIG. 1b) and Li₆PS₅I (FIG. 1c) after heat treatment. All reflections correspond to the respective argyrodite phase except for those which are marked. The argyrodite phase (F-43m) is present as the major crystalline phase (77 wt.-% to 91 wt.-%, see below) in the solid materials having the target stoichiometries Li₆PS₅Cl (FIG. 1a) and

Li₆PS₅Br (FIG. 1b), while the remainder of the crystalline fraction detectable by XRD is comprised of minor amounts of Li₃PO₄, LiCl and LiBr. The solid material having the target stoichiometry Li₆PS₅I contains only a trace of Li₃PO₄ (FIG. 1c).

The SEM images (insets in FIGS. 1a, 1b and 1c) of well-ground solid materials having the target stoichiometries Li₆PS₅Cl (FIG. 1a), Li₆PS₅Br (FIG. 1b), Li₆PS₅I (FIG. 1c) illustrate the dense nature of the obtained materials which is highly beneficial when the solid materials are processed into all solid-state batteries.

The weight fraction of the crystalline argyrodite phase relative to the total weight of crystalline phases detectable by XRD was determined using Si as an external standard (see tables 2 and 3). In the solid materials having the target stoichiometry Li₆PS₅Cl resp. Li₆PS₅Br, the weight percentages of crystalline argyrodite were 77(5)% and 91(6)%, respectively, with crystalline Li₃PO₄, Li₂S, LiCl resp. LiBr accounting for the remainder (Tables 2 and 3). In tables 2 and 3, estimated standard deviations (esd's) are given in parentheses.

TABLE 2
Weight fraction of crystalline phases in the solid material having the target stoichiometry
Li₆PS₅Cl (−10 wt. % Si added as the reference standard for intensity normalization).

| Component | Refined weight fraction with Si | Calculated weight fraction |
|---|---|---|
| Li₆PS₅Cl | 71(2)% | 77(5)% |
| Li₃PO₄ | 9.2(9)% | 10(2)% |
| LiCl | 5.1(3)% | 5.6(5)% |
| Li₂S | 4.8(3)% | 5.2(5)% |
| Si | 10.2(3)% | N/A |

TABLE 3
Weight fraction of crystalline phases in the solid material having the target stoichiometry
Li₆PS₅Br (−10 wt. % Si added as the reference standard for intensity normalization).

| Component | Refined weight fraction with Si | Calculated weight fraction |
|---|---|---|
| Li₆PS₅Br | 78(2)% | 91(6)% |
| Li₃PO₄ | 7(2)% | 8(3)% |
| LiBr | 3.0(2)% | 3.5(4)% |
| Li₂S | 2.9(3)% | 3.3(4)% |
| Si | 9.6(3)% | N/A |

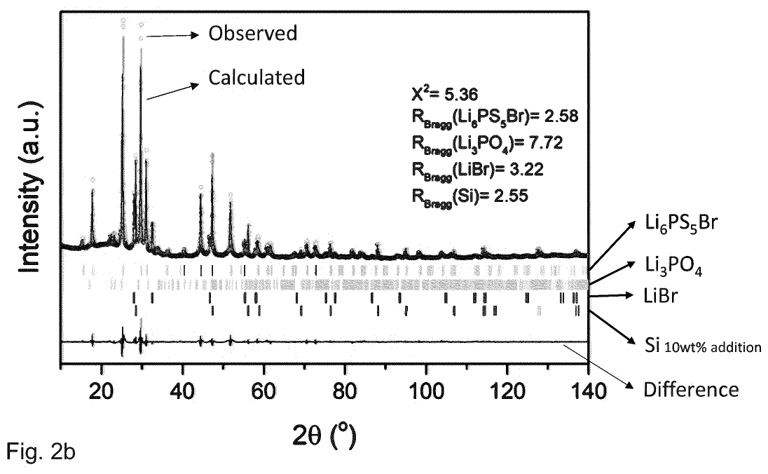

Rietveld refinements of the XRD patterns of the solid materials having the target stoichiometry Li₆PS₅Cl (FIG. 2a) resp. Li₆PS₅Br (FIG. 2b) result in lattice and atomic parameters (see tables 4 and 5 below) similar to those values previously reported by Kraft, M. A.; Culver, S. P.; Calderon, M.; Böcher, F.; Krauskopf, T.; Senyshyn, A.; Dietrich, C.; Zevalkink, A.; Janek, J.; Zeier, W. G. in “Influence of lattice polarizability on the ionic conductivity in the lithium superionic argyrodites Li₆PS₅X (X=Cl, Br, I)”, J. Am. Chem. Soc. 2017, 139, 10909-10918.

In the following tables 4-7, “occ” means occupancy. Estimated standard deviations (esd's) are given in parentheses.

TABLE 4
Atom coordinates, Wyckoff symbols and isotropic
displacement parameters Bᵢₛₒ/Å² for the atoms in Li₆PS₅Cl
(space group = F-43 m, a = 9.8598(3) Å, R_{Bragg} = 4.83, X² = 4.50).

| | Wyckoff | | | | | Bᵢₛₒ |
|---|---|---|---|---|---|---|
| Atom | Site | x | y | z | Occ. | (Å²) |
| Li1 | 48h | 0.3205 | 0.0182 | 0.6798 | 0.5 | 2 |
| Cl1 | 4a | 0 | 0 | 0 | 0.385 | 2.5(2) |
| Cl2 | 4d | 0.75 | 0.75 | 0.75 | 0.615 | 2.5(2) |
| P1 | 4b | 0 | 0 | 0.5 | 1 | 1.71(1) |
| S1 | 16e | 0.1195(2) | −0.1195(2) | 0.6195(2) | 1 | 2.99(5) |
| S2 | 4a | 0 | 0 | 0 | 0.615 | 2.5(2) |
| S3 | 4d | 0.75 | 0.75 | 0.75 | 0.385 | 2.5(2) |

TABLE 5
Atom coordinates, Wyckoff symbols and isotropic displacement
parameters Bᵢₛₒ/Å² for the atoms in Li₆PS₅Br (space
group = F-43 m, a = 9.9855(4) Å, R_{Bragg} = 3.26, X² = 4.71).

| | Wyckoff | | | | | |
|---|---|---|---|---|---|---|
| Atom | Site | x | y | z | Occ. | Bᵢₛₒ (Å²) |
| Li1 | 48h | 0.3071 | 0.0251 | 0.6929 | 0.441 | 2 |
| Li2 | 24g | 0.25 | 0.017 | 0.75 | 0.119 | 2 |
| Br1 | 4a | 0 | 0 | 0 | 0.785(2) | 2.9(1) |
| Br2 | 4d | 0.75 | 0.75 | 0.75 | 0.215(2) | 1.6(1) |
| P1 | 4b | 0 | 0 | 0.5 | 1 | 1.3(1) |
| S1 | 16e | 0.1184(2) | −0.1184(2) | 0.6184(2) | 1 | 1.97(7) |
| S2 | 4a | 0 | 0 | 0 | 0.215(2) | 2.9(1) |
| S3 | 4d | 0.75 | 0.75 | 0.75 | 0.785(2) | 1.6(1) |

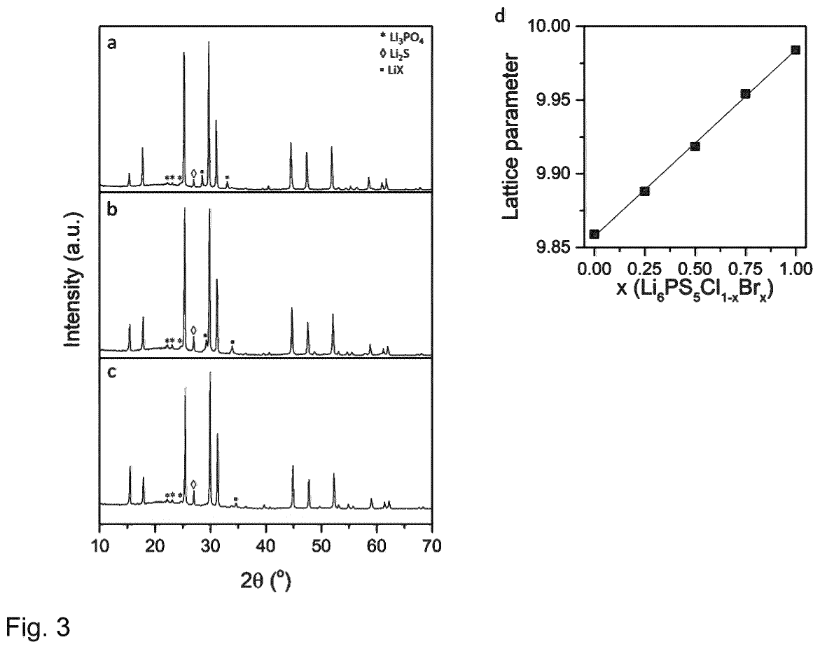

FIGS. 3a-c show the XRD patterns of solid materials having the target stoichiometries Li₆PS₅Cl_{0.25}Br_{0.75} (FIG. 3a), Li₆PS₅Cl_{0.5}Br_{0.5} (FIG. 3b) resp. Li₆PS₅Cl_{0.75}Br_{0.25} (FIG. 3c) after heat treatment. All reflections correspond to the respective argyrodite phase except for the marked reflections. As for the solid materials of single-halide target stoichiometries (cf. FIGS. 1a-1c above), the argyrodite phase is present as the major crystalline phase in each case, beside minor amounts of Li₃PO₄, Li₂S, LiCl and LiBr. The lattice parameters are given in tables 6-8.

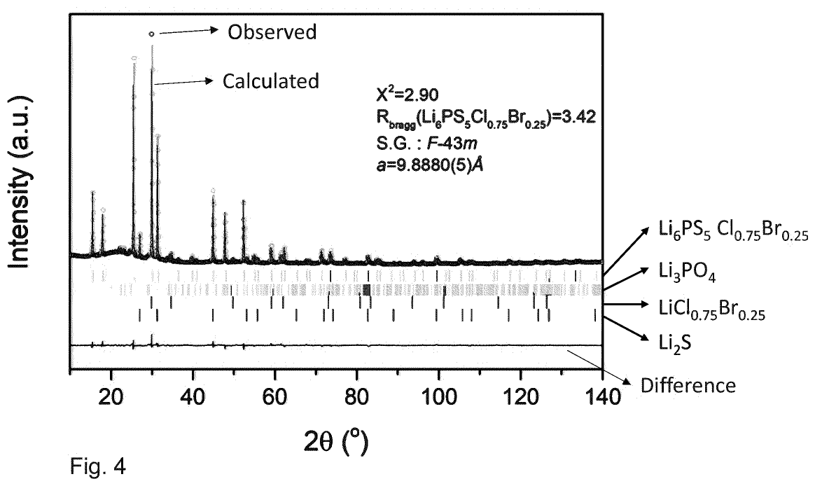

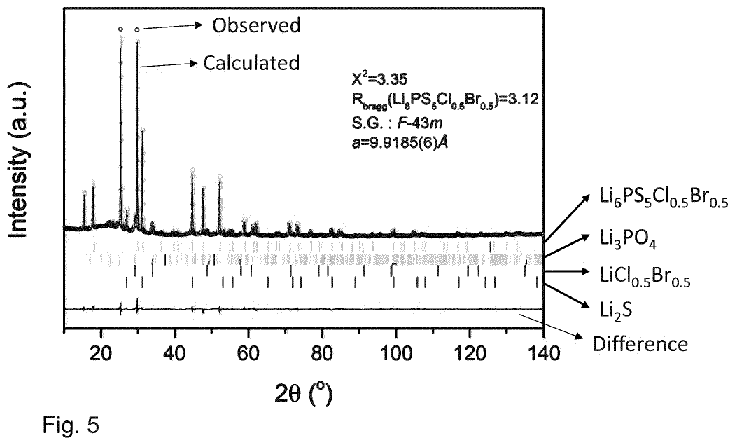

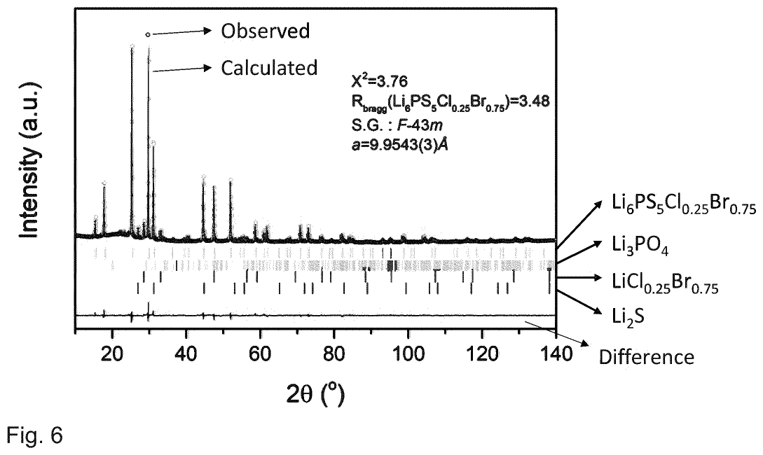

FIG. 3d shows that the lattice parameter obtained from Rietveld refinements (see FIGS. 2a, 2b, 4-6) of the materials having target stoichiometries Li₆PS₅Cl₁₋ₓBrₓ with 0≤x≤1 increases linearly from x=0 to x=1. This indicates that in the argyrodite phases of the materials having mixed halide target stoichiometries Cl⁻ ions and Br ions are randomly disordered throughout the structure.

TABLE 6
Atom coordinates, Wyckoff symbols and isotropic displacement
parameters Bᵢₛₒ/Å² for the atoms in Li₆PS₅Cl_{0.75}Br_{0.25}
(space group = F-43 m, a = 9.8880(4) Å, R_{Bragg} = 3.42, X² = 2.90).

| | Wyckoff | | | | | |
|---|---|---|---|---|---|---|
| Atom | Site | x | y | z | Occ. | Bᵢₛₒ (Å²) |
| Li1 | 48h | 0.3166 | 0.0178 | 0.6834 | 0.5 | 2 |
| Br1 | 4a | 0 | 0 | 0 | 0.22(2) | 2.9(2) |
| Cl1 | 4a | 0 | 0 | 0 | 0.26(2) | 2.9(2) |
| Br2 | 4d | 0.75 | 0.75 | 0.75 | 0.04(2) | 1.3(2) |
| Cl2 | 4d | 0.75 | 0.75 | 0.75 | 0.49(2) | 1.3(2) |
| P1 | 4b | 0 | 0 | 0.5 | 1 | 1.54(8) |
| S1 | 16e | 0.1200(2) | −0.1200(2) | 0.6200(2) | 1 | 2.99(5) |
| S2 | 4a | 0 | 0 | 0 | 0.53(2) | 2.9(2) |
| S3 | 4d | 0.75 | 0.75 | 0.75 | 0.47(2) | 1.3(2) |

TABLE 7
Atom coordinates, Wyckoff symbols and isotropic displacement
parameters Bᵢₛₒ/Å² for the atoms in Li₆PS₅Cl_{0.5}Br_{0.5}
(space group = F-43 m, a = 9.9185(6) Å, R_{Bragg} = 3.12, X² = 3.35).

| | Wyckoff | | | | | |
|---|---|---|---|---|---|---|
| Atom | Site | x | y | z | Occ. | Bᵢₛₒ (Å²) |
| Li1 | 48h | 0.3132 | 0.0212 | 0.6868 | 0.5 | 2 |
| Br1 | 4a | 0 | 0 | 0 | 0.39(2) | 3.0(2) |
| Cl1 | 4a | 0 | 0 | 0 | 0.20(2) | 3.0(2) |
| Br2 | 4d | 0.75 | 0.75 | 0.75 | 0.11(2) | 1.4(2) |
| Cl2 | 4d | 0.75 | 0.75 | 0.75 | 0.30(2) | 1.4(2) |
| P1 | 4b | 0 | 0 | 0.5 | 1 | 1.6(1) |
| S1 | 16e | 0.1194(2) | −0.1194(2) | 0.6194(2) | 1 | 2.86(6) |
| S2 | 4a | 0 | 0 | 0 | 0.41(2) | 3.0(2) |
| S3 | 4d | 0.75 | 0.75 | 0.75 | 0.59(2) | 1.4(2) |

TABLE 8
Atom coordinates, Wyckoff symbols and isotropic displacement
parameters Bᵢₛₒ/Å² for the atoms in Li₆PS₅Cl_{0.25}Br_{0.75}
(space group = F-43 m, a = 9.9543(3) Å, R_{Bragg} = 3.48, X² = 3.76).

| | Wyckoff | | | | | |
|---|---|---|---|---|---|---|
| Atom | Site | x | y | z | Occ. | Bᵢₛₒ (Å²) |
| Li1 | 48h | 0.3138 | 0.0235 | 0.6862 | 0.5 | 2 |
| Br1 | 4a | 0 | 0 | 0 | 0.61(2) | 2.79(9) |
| Cl1 | 4a | 0 | 0 | 0 | 0.10(2) | 2.79(9) |
| Br2 | 4d | 0.75 | 0.75 | 0.75 | 0.14(2) | 1.4(1) |
| Cl2 | 4d | 0.75 | 0.75 | 0.75 | 0.15(2) | 1.4(1) |
| P1 | 4b | 0 | 0 | 0.5 | 1 | 1.02(7) |
| S1 | 16e | 0.1191(1) | −0.1191(1) | 0.6191(1) | 1 | 2.05(4) |
| S2 | 4a | 0 | 0 | 0 | 0.29(2) | 2.79(9) |
| S3 | 4d | 0.75 | 0.75 | 0.75 | 0.71(2) | 1.4(1) |

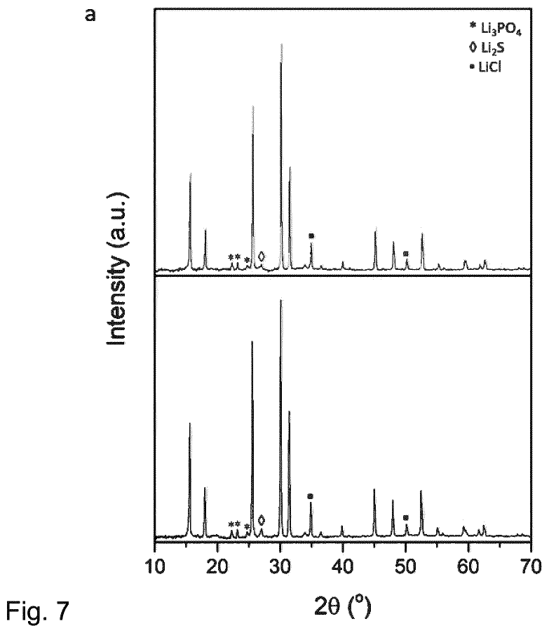

FIG. 7 shows the XRD patterns of solid materials having the target stoichiometries Li_{5.75}PS_{4.75}Cl_{1.25} (upper pattern) and Li_{5.5}PS_{4.5}Cl_{1.5} (lower pattern). All reflections correspond to the respective argyrodite phase except for those marked. The argyrodite phase is present as the major phase in each case, beside minor amounts of Li₃PO₄—and compared to the solid materials having the target stoichiometry Li₆PS₅Cl (cf. FIG. 1a)—much less Li₂S and slightly more LiCl. The XRD patterns indicate successful substitution of sulfur with chlorine, which introduces lithium vacancies in the argyrodite phase, which may further improve the ionic conductivity.

1. A solid material comprising:
Li, P, S, O, and one or more component selected from the group consisting of Cl, Br and I in a molar ratio according to general formula (I):
UaPSbOcXdYe
wherein
X and Y are different and are selected from the group consisting of Cl, Br and I, a is in the range of from 4.5 to 7.5,
b is in the range of from 3.0 to 5.4,
c is in the range of from 0.1 to 2,
b+c is in the range of from 4.4 to 6,
d is in the range of from 0 to 1.6,
e is in the range of from 0 to 1.6,
d+e is in the range of from 0.4 to 1.8, and
b+c+d+e is in the range of from 4.8 to 7.6.

2. The solid material according to claim 1, wherein
the ratio b/c is in the range of from 1.5 to 40.

3. The solid material according to claim 1, wherein
X is Cl and Y is Br,
d+e is in the range of from 0.9 to 1.7, and
the ratio of d/e is in the range of from 1:4 to 4:1.

4. The solid material according to claim 1, wherein
the ratio (b+c)/(d+e) is in the range of from 2.8 to 5.2.

5. The solid material according to claim 1, wherein
the solid material comprises a fraction consisting of crystalline phases,
wherein one of said crystalline phases has the argyrodite structure.

6. The solid material according to claim 1, wherein
the solid material comprises structural units PS₄³⁻ and structural units PO₄³⁻ wherein preferably the ratio between the amount of structural units PS₄³⁻ and the amount of structural units PO₄³⁻ is in the range of from von 30:1 to 1.5:1.

7. The solid material according to claim 1,
wherein the solid material has an ionic conductivity of 1 mS/cm or more.

8. A process for preparing a solid material according to claim 1, said process comprising:
a) providing the precursors
(1) a compound of formula (II)
U3PS4 (II)
and/or
a mixture of U2S and P₂S₅ in a molar ratio in the range of from 2.7:1 to 3.3:1 preferably 2.9:1 to 3.1:1,
(2) U2S,
(3) one or more compounds selected from the group consisting of LiCl, LiBr and LiI,
and
(4) one or more solvents selected from the group consisting of alkanol;
b) preparing a mixture comprising the precursors and solvents provided in a); and
c) converting the mixture prepared in b) to a solid material by removing the solvents to form a residue, and heating the residue at a temperature in the range of from 50° C. up to 600° C. to form the solid material.

9. The process according to claim 8, wherein
in b) the precursors (2) and (3) are dissolved in solvent (4) resp. in a mixture of solvents (4) and (5), then precursor (1) is added and dissolved, and the obtained solution is stirred for 15 min to 24 hours,
and/or
in c) heating is performed in a closed vessel for a duration of 1 to 12 hours, at a temperature in the range of from 50° C. up to 600° C.

10. The process according to claim 8, wherein
the molar ratio of the total amount of Li in precursor (1) to the total amount of Li in precursors (2) and (3) is in the range of from 3:5 to 3:1, preferably 3:4.7 to 3:1.3, and
the molar ratio of Li in precursor (2) to Li in precursor (3) is in the range of from 1:2 to 4:1, more preferably 2:3.5 to 3:1.

11. The process according to claim 8,
the compound of formula (II) is provided in solvated form
Li₃PS₄*g solv (If)
wherein
solv is selected from the group consisting of tetrahydrofuran (THF), acetonitrile, dimethylether (DME), 1,3-dioxolane, 1,4-dioxane
g is in the range of from 1 to 4, preferably 2 to 3.5.

12. The process according to claim 8, wherein
precursor (3) consists of the compounds LiCl and LiBr.

13. A method of using the solid material according to claim 1 as a solid electrolyte for an electrochemical cell, wherein the solid electrolyte is a component of a solid structure for an electrochemical cell selected from the group consisting of a cathode, anode and separator.

14. A solid structure for an electrochemical cell, wherein said solid structure is selected from the group consisting of cathode, anode and separator, wherein the solid structure for an electrochemical cell comprises a solid material according to claim 1.

15. An electrochemical cell comprising:
a solid material according to claim 1, wherein the solid material is a component of the solid structure of claim 14.

16. The solid material of claim 1, wherein b+c+d+e is in the range of from 4.8 to 7.6.

17. The solid material according to claim 16, wherein, b+c+d+e is in the range of 5.5 to 6.7.

18. The solid material according to claim 1, wherein a=3+2(b+c−4)+d+e.

19. The solid material according to claim 5, wherein said crystalline phase having the argyrodite phase makes up for 70% or more of the total weight of the fraction comprising crystalline phases.

20. The method of claim 9, wherein the precursors further comprise:
(5) one or more solvents selected from the group consisting of aprotic solvents, wherein said aprotic solvents are selected from the group consisting of ethers, aliphatic hydrocarbons and aromatic hydrocarbons, most preferably one or both of tetrahydrofuran (THF) and toluene.
